(19) United States
(12) Patent Application Publication
(10) Pub. No.: US 2019/0136876 A1
(43) Pub. Date: May 9, 2019

(54) ELECTRO-HYDRAULIC OR ELECTRO-PNEUMATIC SERVO-ACTUATOR USING KHAYYAM TRIANGLE

(71) Applicant: Shahin Fallahi, Alborz (IR)

(72) Inventor: Shahin Fallahi, Alborz (IR)

(21) Appl. No.: 16/005,240

(22) Filed: Jun. 11, 2018

Related U.S. Application Data
(60) Provisional application No. 62/517,886, filed on Jun. 10, 2017.

(51) Int. Cl. F15B 11/046; F15B 11/10

(52) U.S. Cl. CPC F15B 11/046; F15B 11/10; F15B 2211/6336; F15B 2211/426; F15B 2211/7054; F15B 2211/7052; F15B 2211/75

(57) ABSTRACT

An actuator includes a cylinder, a first 2/2-way solenoid valve, a second 2/2-way solenoid valve, a fuzzy block, a controller, a source, a silencer, and a sensor. The cylinder is configured to receive a piston. The piston defines a first chamber and a second chamber inside the cylinder. The first 2/2-way solenoid valve includes an input terminal and a plurality of ports. The second solenoid valve includes an input terminal and a plurality of ports. The fuzzy block includes a plurality of phases each phase including a 2/2-way solenoid valve and a flow control valve for controlling the speed of movement of the piston within the cylinder. The controller is configured to issue a control signal for controlling the first and second 2/2-way solenoid valves and the 2/2-way solenoid valves included within the plurality of phases.

### CROSS REFERENCE TO RELATED APPLICATION

This application claims the benefit of priority to a Provisional Application Ser. No. 62/517,886 filed on Jun. 10, 2017 and titled, “One-way Electro-Hydraulic or Electro-Pneumatic Servo Actuator,” the entire content of which are incorporated herein by reference.

### TECHNICAL FIELD

The present application relates generally to Electro-Hydraulic or Electro-Pneumatic Servo-actuator, and more particularly to Electro-Hydraulic or Electro-Pneumatic Servo-actuator using the Khayyam Triangle.

### BACKGROUND

Situations arise in equipment design that require controlled positioning and repositioning of a member (load). Numerous factors are involved in the selection of the type of actuator that is utilized to produce the positioning movements of the member, such as the nature of the equipment, the magnitudes of the forces required to both translate the member from position to position and to hold the member in a desired position, and the available power sources for the actuator. When fluid power, typically pressurized hydraulic fluid or compressed air, is available, a hydraulic (pneumatic) cylinder is the actuator of choice.

The conventional servo actuators may be expensive with complicated structures. Hence, there is a need for an improved servo actuator.

### BRIEF DESCRIPTION OF THE DRAWINGS

Features of the subject technology are set forth in the appended claims. However, for purpose of explanation, several implementations of the subject technology are set forth in the following figures.

FIG. 1 illustrates an exemplary servo actuator control system;

FIG. 2 illustrates an exemplary actuator of the control system shown in FIG. 1:

FIG. 3 illustrates an exemplary fuzzy block of the actuator shown in FIG. 2;

FIG. 4 illustrates another exemplary actuator of the control system shown in FIG. 1;

FIG. 5 illustrates an exemplary fuzzy block of the actuator shown in FIG. 4;

FIG. 6 illustrates another exemplary actuator of the control system shown in FIG. 1;

FIG. 7 illustrates another exemplary actuator of the control system shown in FIG. 1; and

FIG. 8 illustrates an exemplary Khayyam triangle.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. As part of the description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

The instant application describes an improved servo actuator with on-off solenoid valves for controlling the piston position in a cylinder. The applications of the present servo actuator are vast and may include applications in robotics, aircraft's control surfaces, automatic machine tools, satellite tracking antennas, hydraulic or pneumatic braking systems, power plant turbine governors, control valve positioners, etc.

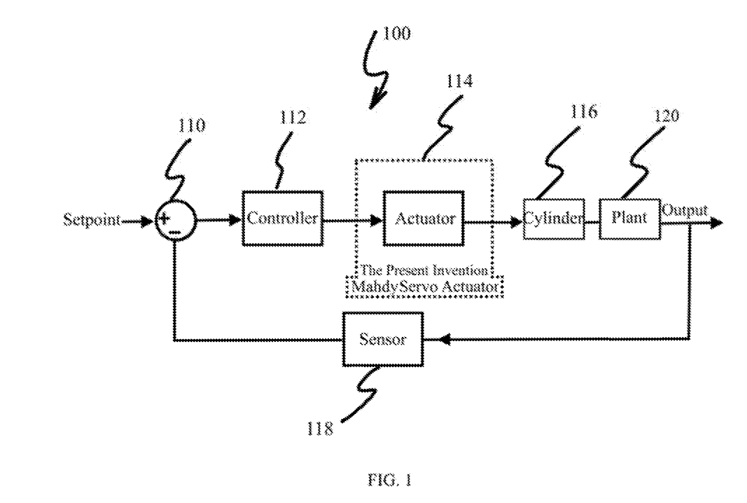

FIG. 1 illustrates an exemplary servo actuator control system 100. The system 100 includes an operational amplifier 110, a controller 112, an actuator 114, a cylinder 116, a plant 120 and a sensor 118. The operational amplifier 110 is configured to receive as an input the predetermined setpoint value and the output of the sensor 118 and output the difference between the predetermined setpoint value and the output of the sensor 118 to the controller 112. The controller 112 is configured to control the operation of the actuator 114 based on the output of the amplifier 110. In one implementation, the controller 112 is positioned outside of the actuator 114 as shown. In another implementation, the controller 112 is positioned within the actuator 114.

The actuator 114 may include a plurality of solenoid valves and a fuzzy block to control the cylinder 116. The solenoid valve may include 2/2-way solenoid valve. In one implementation, the actuator 114 is configured to move the piston within the cylinder 116 forward or backward depending on the control signal received from the controller 112. In another implementation, the actuator 114 is configured to control both the forward and backward speed of the movement of the piston within the cylinder 116. The forward or backward movement of the piston depends on the current position of the piston within the cylinder 116. The current position of the piston may be detected using the sensor 118.

The sensor 118 may include a potentiometer and is connected to the cylinder 116. The sensor 118 is configured to sense the position of the piston and send an electrical position signal to the controller 112. The controller 112 is configured to generate the control signal based on the electrical position signal received from the sensor 118. In one implementation, the controller 112 is configured to compute a difference between the electrical position signal and a reference signal and determine whether the position of the piston is lower than a desired position or higher than the desired position. In this implementation, the amplifier 110 may be placed within the controller 112.

A plant 120 may include vast applications such as robotics, aircraft's control surfaces, automatic machine tools, satellite tracking antennas, hydraulic or pneumatic braking systems, power plant turbine governors, control valve positioners, etc. According to variables which we want to control, the sensor 118 will be changed. For example, if controlling the speed of power turbine is desirable, a plant 120 will be turbine (gas, steam or hydro turbine), the variable is turbine speed and a sensor 118 will be turbine speed sensor.

In one implementation, the cylinder 116 may not be included in the system 100 and the plant 120 may be connected directly to the actuator 114. Alternatively, the plant 120 may be part of the actuator 116. For example, the system 100 may correspond to a governor and/or a control valve positioner. In the governor, the actuator 114 may be connected to a wicket gate for water turbine and instead of position sensor turbine speed sensor may be used. The control valve positioner may include a control valve having a stem and the stem may be controlled by the actuator 114.

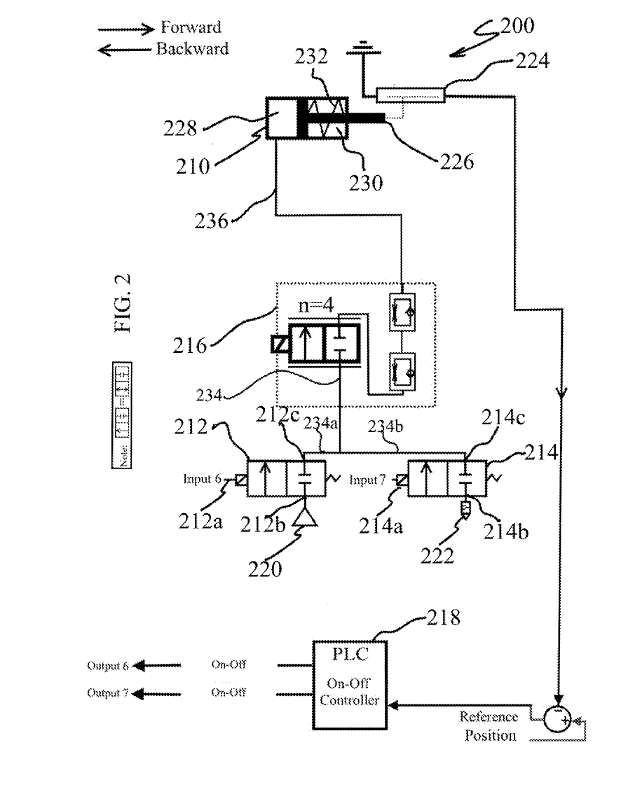

FIG. 2 illustrates an exemplary servo actuator 200 of the control system 100 shown in FIG. 1. The servo actuator 200 includes a cylinder 210, a first 2/2-way solenoid valve 212, a second 2/2-way solenoid valve 214, a fuzzy block 216, a controller 218, a source 220, a silencer 222, and a sensor 224. In one implementation, the cylinder 210, the sensor 224, and the controller 218 are placed outside of the actuator as shown in FIG. 1. However, they are shown here for the sake of simplicity and easier understanding of concepts.

The cylinder 210 at one end is connected to the sensor 224 and at another end is connected to the fuzzy block 216. The cylinder 210 is configured to receive a piston 226. The piston 226 slideably moves within the cylinder 210. The piston 226 is configured to define a first chamber 228 and a second chamber 230 inside the cylinder 210. Within the first chamber 228 compressed air or fluid may be placed. Within the second chamber 230 a spring 232 may be placed.

The first solenoid valve 212 includes an input terminal 212a, a first port 212b, and a second port 212c. The first solenoid valve 212 includes a 2/2-way solenoid valve. The input terminal 212a is connected to the controller 218. The first port 212b is connected to the source 220. The second port 212c is connected to the fuzzy block 216. The first solenoid valve 212 includes a first position connecting the first port 212b to the second port 212c, and a second condition disconnecting the first port 212b from the second port 212c. The first position is activated when the input terminal 212a receives an ON or active signal from the controller 218. The second position is activated when the input terminal 212a receives an OFF or deactivate signal from the controller 218.

In the first position, the source 220 is connected to the first chamber 228 through the first and second ports 212b, 212c, lines 234, 234a, fuzzy block 216 and line 236. The source 220 may be compressed air or pressurized hydraulic fluid such as produced at the pressured regulated output of a sump pump. If hydraulic fluid is utilized as the power source, fluid valves would vent the actuator chambers to a sump. In the second position, the source 220 is disconnected from the first chamber 228 be disconnecting the first and second ports 212b and 212c.

The second solenoid valve 214 includes an input terminal 214a, a first port 214b, and a second port 214c. The second solenoid valve 214 includes 2/2-way solenoid valve. The input terminal 214a is connected to the controller 218. The first port 214b is connected to the silencer 222. The second port 214c is connected to the fuzzy block 216. The second solenoid valve 214 includes a first position connecting the first port 214b to the second port 214c, and a second condition disconnecting the first port 214b from the second port 214c. The first position is activated when the input terminal 214a receives an ON or active signal from the controller 218. The second position is activated when the input terminal 214a receives an OFF or deactivate signal from the controller 218.

In the first position, the silencer 222 is connected to the first chamber 228 through the first and second ports 214b, 214c, lines 234, 234b, fuzzy block 216 and line 236. The silencer 222 may be configured to reduce noise during exist of pressure from the cylinder. The pressure may be either air or fluid pressure.

In one implementation, the controller 218 sends the signal to the input terminals 212a and 214a. When the input terminal 212a receives the ON signal, the source 220 is connected to the first chamber 228 and the silencer 222 is disconnected from the first chamber 228. This configuration causes air or fluid depending on the type of the source 220 to flow through the lines 234, 234a, and 236 and into the first chamber 228. In this manner, the piston 226 is moved forward within the cylinder 210 and the spring 232 is compressed within the second chamber 230. When the input terminal 214a receives the ON signal, the source 220 is disconnected from the first chamber 228 and the silencer 222 is connected to the first chamber 228. This configuration causes the spring 232 which is in a compressed state to push the piston 226 backward thereby causing air or fluid depending on the type of the source 220 to flow out of the first chamber 228 through the lines 234, 234b, and 236 and the silencer 222.

The line 234 is connected to the line 236 through the fuzzy block 216. The fuzzy block 216 includes a plurality of phases each phase including a 2/2-way solenoid valve and two flow control valves for controlling the speed of movement of the piston within the cylinder 210.

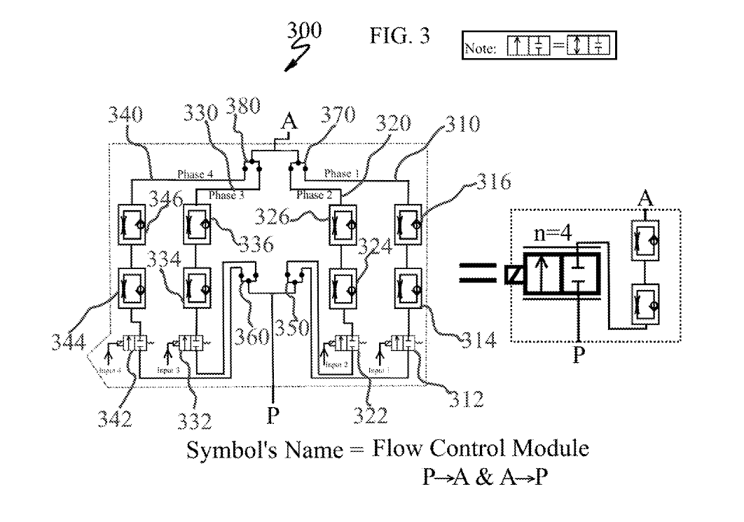

FIG. 3 illustrates an exemplary fuzzy block 300. The fuzzy block 300 may correspond to the fuzzy block 216 of the actuator 200 shown in FIG. 2. The fuzzy block 300 at one end is connected to line 234 from point P and at another end is connected to line 236 at point A. The fuzzy block 300 includes a first phase 310, a second phase 320, a third phase 330, a fourth phase 340, a first three-way fitting 350, a second three-way fitting 360, a third three-way fitting 370, and a fourth three-way fitting 380. The first, second, third and fourth phases are connected in parallel to each other. Specifically, the first phase 310 is connected at one end to line 234 via the first three-way fitting 350 and at another end to line 236 via the third three-way fitting 370. Similarly, the second phase 320 is connected at one end to line 234 via the first three-way fitting 350 and at another end to line 236 via the third three-way fitting 370. Similarly, the third phase 330 is connected at one end to line 234 via the second three-way fitting 360 and at another end to line 236 via the fourth three-way fitting 380. Similarly, the fourth phase 340 is connected at one end to line 234 via the second three-way fitting 360 and at another end to line 236 via the fourth three-way fitting 380.

Each of three-way fittings 350, 360, 370, and 380 may have a plurality of states. In one specific example, each of the three-way fittings 350, 360, 370, and 380 may have four states. The first three-way fitting 350 in a first state connects line 234 to the first phase 310, in a second state connects line 234 to the second phase 320, and in a third state disconnects line 234 from both the first and second phases 310, 320, and in a fourth state connects line 234 to both the first and second phases 310, 320. The second three-way fitting 360 in a first state connects line 234 to the third phase 330, in a second state connects line 234 to the fourth phase 340, in a third state state disconnects line 234 from both the first and second phases 330, 340, and in a fourth state connects line 234 to both the first and second phases 310, 320. The third three-way fitting 370 in a first state connects the first phase 310 to the line 236, in a second state connects the second phase 320 to the line 236, in a third state disconnects the first and second phases 310, 320 from the line 236, and in a fourth state connects the first and second phases 310, 320 to the line 236. The fourth three-way fitting 380 in a first state connects the third phase 330 to the line 236, in a second state connects the fourth phase 340 to the line 236, in a third state disconnects the third and fourth phases 330, 340 from the line 236, and in a fourth state connects the third and fourth phases 330, 340 to the line 236.

In one implementation, when the first three-way fitting 350 is in the first state, the third three-way fitting 370 is also in the first state. Similarly, when the first three-way fitting 350 is in the second state, the third three-way fitting 370 is also in the second state. In another implementation, when the second three-way fitting 360 is in the first state, the fourth three-way fitting 380 is also in the first state. Similarly, when the second three-way fitting 360 is in the second state, the fourth three-way fitting 380 is also in the second state.

In one implementation, depending on the control signal, at least one of the phases 310, 320, 330, and 340 is connected to the lines 234 and 236.

The first phase 310 includes a first phase solenoid valve 312 and a plurality of first phase two-way flow control valves 314, 316. The first phase solenoid valve 312 may include a 2/2-way solenoid valve. The first phase two-way flow control valve 316 include a forward valve for manually setting a speed of the piston moving forward to a first speed. The first phase two-way flow control valve 314 includes a backward valve for manually setting a speed of the piston moving backward to the first speed. In one implementation, the speed may be predetermined and the valve may be adjusted by the user.

The second phase 320 includes a second phase solenoid valve 322 and a plurality of second phase two-way flow control valves 324, 326. The second phase two-way flow control valve 326 include a forward valve for manually setting a speed of the piston moving forward to a second speed. The second phase two-way flow control valve 324 includes a backward valve for manually setting a speed of the piston moving backward to the second speed. In one implementation, the second speed may be predetermined and the valve may be adjusted by the user.

The third phase 330 includes a third phase solenoid valve 332 and a plurality of third phase two-way flow control valves 334, 336. The third phase two-way flow control valve 336 include a forward valve for manually setting a speed of the piston moving forward to a third speed. The third phase two-way flow control valve 334 includes a backward valve for manually setting a speed of the piston moving backward to the third speed. In one implementation, the third speed may be predetermined and the valve may be adjusted by the user.

The fourth phase 340 includes a fourth phase solenoid valve 342 and a plurality of third phase two-way flow control valves 344, 346. The fourth phase two-way flow control valve 344 includes a backward valve for manually setting a speed of the piston moving backward to the fourth speed. In one implementation, the fourth speed may be predetermined and the valve may be adjusted by the user.

In one implementation, the first, second, third, and fourth speed are in the descending order. In another implementation, the first, second, third, and fourth speed are in an ascending order.

The controller 218 may be configured to issue a control signal for controlling the first and second 2/2-way solenoid valves 212, 214, and the 2/2-way solenoid valves 312, 322, 332, and 342. The controller 218 may be configured to generate the control signal based on the electrical position signal received from the sensor 224. The sensor 224 may be connected to the piston 226 and configured to sense the position of the piston 226 and send an electrical position signal to the controller 218. The sensor 224 may be a potentiometer.

The controller 218 may compute a difference between the electrical position signal and a reference signal, and determine whether the position of the piston 226 is lower than a desired position or higher than the desired position. Upon determining the piston 226 is lower than the desired position, the controller 218 is configured to issue an ON signal to the first 2/2-way solenoid valve 212 and an OFF signal to the second 2/2-way solenoid valve 214. The controller 218 also issues a phase control signal to activate one of phases 310, 320, 330, and 340 and thereby connecting the source 220 to the first chamber 228 via the one of phases 310, 320, 330, and 340. This will result in the forward movement of the piston 226.

The phases 310, 320, 330, and 340 are used to control the speed of the piston 226 moving forward by connecting the source 220 to the first chamber 228. In order to move the piston 226 forward, the speed of all phases are adjusted by the two-way flow control valves 316, 326, 336, and 346 described as follows: The piston speed moving forward in the first phase 310 >second phase 320 >third phase 330 >fourth phase 340.

If the first control signal from the controller 218 is between 75% to 100% of maximum value, the first output of the controller 218 activates the input of the first phase solenoid valve 312. The first phase 310 will be ready to actuate the piston 226 by passing pneumatic (pressurized air) through the two-way flow control valve 316 from source 220 to the first chamber 228. If the first control signal from the controller 218 is between 50% to 75% of maximum value, the second output of the controller 218 actuates the input of the second phase solenoid valve 322. The second phase 320 will be ready to actuate the piston 226 by passing pneumatic (pressurized air) through the two-way flow control valve 326 from source 220 to the first chamber 228. If the first control signal from the controller 218 is between 25% to 50% of maximum value, the third output of the controller 218 actuates the input of the third phase solenoid valve 332. The third phase 330 will be ready to actuate the piston 226 by passing pneumatic (pressurized air) through the two-way flow control valve 336 from source 220 to the first chamber 228. If the first control signal from the controller 218 is between 0% to 25% of maximum value, the fourth output of the controller 218 actuates the input of the fourth phase solenoid valve 342. The fourth phase 340 will be ready to actuate the piston 226 by passing pneumatic (pressurized air) through the two-way flow control valve 346 from source 220 to the first chamber 228.

Upon determining the piston 226 is higher than the desired position, the controller 218 is configured to issue an OFF signal to the first 2/2-way solenoid valve 212 and an ON signal to the second 2/2-way solenoid valve 214. The controller 218 also issues a phase control signal to activate one of phases 310, 320, 330, and 340 and thereby connecting the silencer 222 to the first chamber 228 via the one of phases 310, 320, 330, and 340. This will result in the backward movement of the piston 226.

The phases 310, 320, 330, and 340 are used to control the speed of the piston 226 moving backward by connecting the silencer 222 to the first chamber 228. In order to move the piston 226 backward, the speed of all phases are adjusted by the two-way flow control valves 314, 324, 334, and 344 described as follows: The piston speed moving backward in the first phase 310 >second phase 320 >third phase 330 >fourth phase 340.

If the second control signal from the controller 218 is between 75% to 100% of maximum valve, the first output of the controller 218 activates the input of the first phase solenoid valve 312. The first phase 310 will be ready to actuate the piston 226 by passing pneumatic (pressurized air) through the two-way flow control valve 314 from the chamber 228 to the silencer 222. If the second control signal from the controller 218 is between 50% to 75% of maximum valve, the second output of the controller 218 actuates the input of the second phase solenoid valve 322. The second phase 320 will be ready to actuate the piston 226 by passing pneumatic (pressurized air) through the two-way flow control valve 324 from the first chamber 228 to the silencer 222. If the second control signal from the controller 218 is between 25% to 50% of maximum valve, the third output of the controller 218 actuates the input of the third phase solenoid valve 332. The third phase 330 will be ready to actuate the piston 226 by passing pneumatic (pressurized air) through the two-way flow control valve 334 from the first chamber 228 to the silencer 222. If the second control signal from the controller 218 is between 0% to 25% of maximum valve, the fourth output of the controller 218 actuates the input of the fourth phase solenoid valve 342. The fourth phase 340 will be ready to actuate the piston 226 by passing pneumatic (pressurized air) through the two-way flow control valve 344 from the first chamber 228 to the silencer 222.

In the forward movement of the piston 226, the two-way flow control valves 314, 324, 334, and 344 are not active and as such act as a passthrough without controlling the pressure of air or fluid. In contrast, in the forward movement of the piston 226, the two-way flow control valves 316, 326, 336, and 346 are active and as such control pressure of air or fluid. In the backward movement of the piston 226, the two-way flow control valves 316, 326, 336, and 346 are not active and as such act as a passthrough without controlling the pressure of air or fluid. In contrast, in the forward movement of the piston 226, the two-way flow control valves 314, 324, 334, and 344 are active and as such control pressure of air or fluid.

The following is going to now describe the operation of the fuzzy block 216 in more details with respect to forward movement of the piston 226. Here, the first control signal is active, the first 2/2-way solenoid valve 212 is ON and the source 220 is connected to the first chamber 228 through the fuzzy block 216. In this scenario, the second 2/2-way solenoid valve 214 is OFF and the silencer is not connected to the first chamber 228 through the fuzzy block 216.

If the first control signal is between 75% to 100% of maximum valve, the controller 218 is configured to issue a first phase control signal to turn ON the first phase solenoid valve 312 and place the first three-way fitting 350 and third three-way fitting 370 into the first state. The first phase solenoid valve 312 is similar to the 2/2-way solenoid valve 212 and includes an input terminal, a first port, and a second port. When the input terminal receives the ON signal, the first port and second port are connected to each other thereby connecting the source 220 to the first chamber 228. When connected to the source 220, the first phase two-way flow control valve 316 is active and the first phase two-way flow control valve 314 is not active. In an active state, valves 314 and 316 adjusts an amount of flow passing through to set the movement speed of the piston to a first speed. In a not active state, valves 314 and 316 act as a passthrough and do not alter the amount of flow.

If the first control signal is between 50% to 75% of maximum valve, the controller 218 is configured to issue a second phase control signal to turn ON the second phase solenoid valve 322 and place the first three-way fitting 350 and third three-way fitting 370 into the second state. The second phase solenoid valve 322 is similar to the 2/2-way solenoid valve 212 and includes an input terminal, a first port, and a second port. When the input terminal receives the ON signal, the first port and second port are connected to each other thereby connecting the source 220 to the first chamber 228. When connected to the source 220, the second phase two-way flow control valve 326 is active and the second phase two-way flow control valve 324 is not active. In an active state, valves 324 and 326 adjusts an amount of flow passing through to set the movement speed of the piston to a second speed. In a not active state, valves 324 and 326 act as a passthrough and do not alter the amount of flow.

If the first control signal is between 25% to 50% of maximum valve, the controller 218 is configured to issue a third phase control signal to turn ON the third phase solenoid valve 332 and place the second three-way fitting 360 and fourth three-way fitting 380 into the first state. The third phase solenoid valve 332 is similar to the solenoid valve 212 and includes an input terminal, a first port, and a second port. When the input terminal receives the ON signal, the first port and second port are connected to each other thereby connecting the source 220 to the first chamber 228. When connected to the source 220, the third phase two-way flow control valve 336 is active and the third phase two-way flow control valve 334 is not active. In an active state, valves 334 and 336 adjusts an amount of flow passing through to set the movement speed of the piston to a third speed. In a not active state, valves 334 and 336 act as a passthrough and do not alter the amount of flow.

If the first control signal is between 0% to 25% of maximum valve, the controller 218 is configured to issue a fourth phase control signal to turn ON the fourth phase solenoid valve 342 and place the second three-way fitting 360 and fourth three-way fitting 380 into the second state. The fourth phase solenoid valve 342 is similar to the 2/2-way solenoid valve 212 and includes an input terminal, a first port, and a second port. When the input terminal receives the ON signal, the first port and second port are connected to each other thereby connecting the source 220 to the first chamber 228. When connected to the source 220, the fourth phase two-way flow control valve 346 is active and the fourth phase two-way flow control valve 344 is not active. In an active state, valves 344 and 346 adjusts an amount of flow passing through to set the movement speed of the piston to a fourth speed. In a not active state, valves 344 and 346 act as a passthrough and do not alter the amount of flow.

In one implementation, the controller 218 is configured to gradually reduce the forward speed of the piston 226 by alternatively activating and deactivating the one of phases. Specifically, the controller 218 may first activate the first phase 310, then second phase 320, then third phase 330, and then the fourth phase 340 as the piston 226 gets closer to the desired forward position.

The following is going to now describe the operation of the fuzzy block 216 in more details with respect to backward movement of the piston 226. Here, the second control signal is active, the second 2/2-way solenoid valve 214 is ON and the silencer 222 is connected to the first chamber 228 through the fuzzy block 216. In this scenario, the first 2/2-way solenoid valve 212 is OFF and the source 220 is not connected to the first chamber 228 through the fuzzy block 216.

If the second control signal is between 75% to 100% of maximum valve, the controller 218 is configured to issue a first phase control signal to turn ON the first phase solenoid valve 312 and place the first three-way fitting 350 and third three-way fitting 370 into the first state. The first phase solenoid valve 312 is similar to the 2/2-way solenoid valve 212 and includes an input terminal, a first port, and a second port. When the input terminal receives the ON signal, the first port and second port are connected to each other thereby connecting the silencer 222 to the first chamber 228. When connected to the silencer 222, the first phase two-way flow control valve 314 is active and the first phase two-way flow control valve 316 is not active. The two-way flow control valve 314 sets the backward movement of the piston 226 to a first speed.

If the second control signal is between 50% to 75% of maximum valve, the controller 218 is configured to issue a second phase control signal to turn ON the second phase solenoid valve 322 and place the first three-way fitting 350 and third three-way fitting 370 into the second state. The second phase solenoid valve 322 is similar to the 2/2-way solenoid valve 212 and includes an input terminal, a first port, and a second port. When the input terminal receives the ON signal, the first port and second port are connected to each other thereby connecting the silencer 222 to the first chamber 228. When connected to the silencer 222, the second phase two-way flow control valve 324 is active and the second phase two-way flow control valve 326 is not active. The two-way flow control valve 324 sets the backward movement of the piston 226 to a second speed.

If the second control signal is between 25% to 50% of maximum valve, the controller 218 is configured to issue a third phase control signal to turn ON the third phase solenoid valve 332 and place the second three-way fitting 360 and fourth three-way fitting 380 into the first state. The third phase solenoid valve 332 is similar to the 2/2-way solenoid valve 212 and includes an input terminal, a first port, and a second port. When the input terminal receives the ON signal, the first port and second port are connected to each other thereby connecting the silencer 222 to the first chamber 228. When connected to the silencer 222, the third phase two-way flow control valve 334 is active and the third phase two-way flow control valve 336 is not active. The two-way flow control valve 334 sets the backward movement of the piston 226 to a third speed.

If the second control signal is between 0% to 25% of maximum valve, the controller 218 is configured to issue a fourth phase control signal to turn ON the fourth phase solenoid valve 342 and place the second three-way fitting 360 and fourth three-way fitting 380 into the second state. The fourth phase solenoid valve 342 is similar to the 2/2-way solenoid valve 212 and includes an input terminal, a first port, and a second port. When the input terminal receives the ON signal, the first port and second port are connected to each other thereby connecting the silencer 222 to the first chamber 228. When connected to the silencer 222, the fourth phase two-way flow control valve 344 is active and the fourth phase two-way flow control valve 346 is not active. The two-way flow control valve 344 sets the backward movement of the piston 226 to a fourth speed.

In one implementation, the controller 218 is configured to gradually reduce the backward speed of the piston 226 by alternatively activating and deactivating the one of phases. Specifically, the controller 218 may first activate the first phase 310, then second phase 320, then third phase 330, and then the fourth phase 340 as the piston 226 gets closer to the desired backward position.

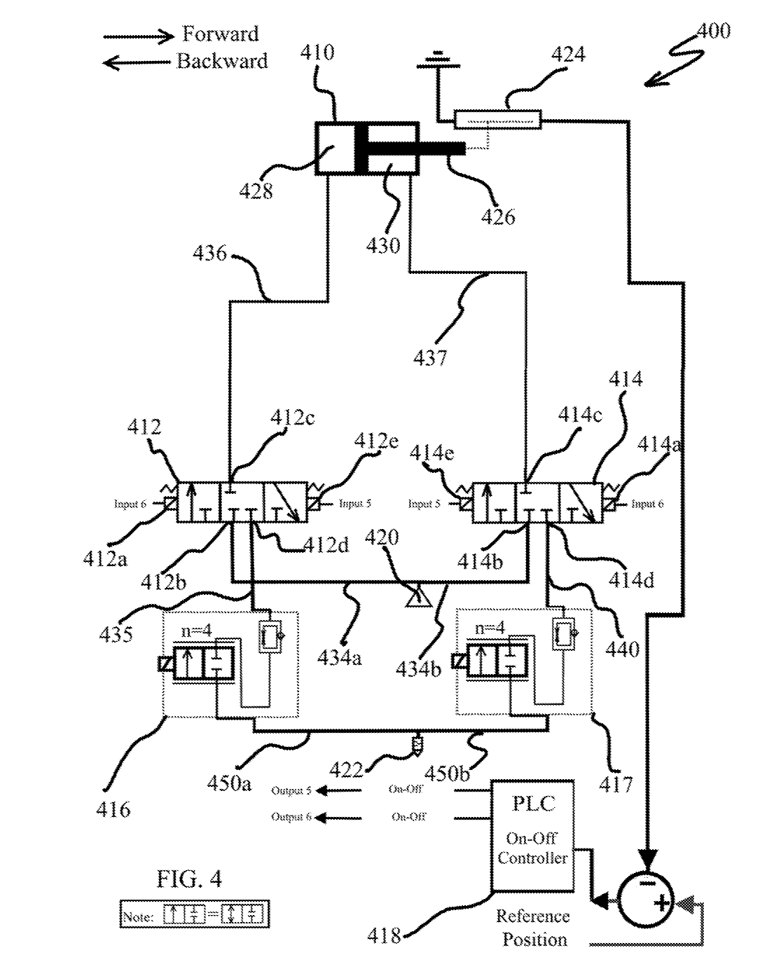

FIG. 4 illustrates another exemplary actuator 400 of the control system shown in FIG. 1. The servo actuator 400 includes a cylinder 410, a first 3/3-way solenoid valve 412, a second 3/3-way solenoid valve 414, fuzzy blocks 416 and 417, a controller 418, a source 420, a silencer 422, and a sensor 424. The cylinder 410, source 420, silencer 422, and the sensor 424 are similar to cylinder 210, source 220, silencer 222, and the sensor 224. Therefore, their redundant aspects are not described here in more details.

The cylinder 410 is different from the cylinder 210 in that in the second chamber 430 there is no spring.

The first 3/3-way solenoid valve 412 at one end is connected to the first chamber 428 of the cylinder 410 via line 436 and at another end is connected to the source 420 via line 434a and fuzzy block 416 via line 435. The fuzzy block 416 at one end is connected to the first 3/3-way solenoid valve 412 via line 435 and at another end is connected to the silencer 422 via line 450a.

The second 3/3-way solenoid valve 414 at one end is connected to the second chamber 430 of the cylinder 410 via line 437 and at another end is connected to the source 420 via line 434b and fuzzy block 417 via line 440. The fuzzy block 417 at one end is connected to the second 3/3-way solenoid valve 414 via line 440 and at another end is connected to the silencer 422 via line 450b.

The controller 418 may be similar to controller 218. To this end, the controller 418 may be configured to issue a control signal for controlling the first and second 3/3-way solenoid valves 412, 414, and fuzzy blocks 416, 417. The controller 418 may be configured to generate the control signal based on the electrical position signal received from the sensor 424.

If the position signal indicates that the piston 426 is lower than the desired position, the controller 418 activates the 3/3-way solenoid valves 412 and 414 via electrical input terminals 412a and 414a such that the source 420 is connected to the first chamber 428 and activates the second 3/3-way solenoid valve 414 such that the second chamber 430 is connected to the silencer 422 through the fuzzy block 417. In this manner, the pressure (air or fluid) is transferred from the source 420 through the lines 434a, 436 to the first chamber 428 and the pressure is transferred from the second chamber 430 through the lines 437, 440, 450b to the silencer 422. This causes the forward movement of the piston 426. The speed of the forward movement is controlled via the fuzzy block 417. Specifically, the controller 418 can issue various control signals to the fuzzy block 417 to increase or decrease the forward movement speed of the piston 426.

If the position signal indicates that the piston 426 is higher than the desired position, the controller 418 activates the 3/3-way solenoid valves 414 and 412 via electrical input terminals 414e and 412e such that the source 420 is connected to the second chamber 430 and activates the first 3/3-way solenoid valve 412 such that the first chamber 428 is connected to the silencer 422 through the fuzzy block 416. In this manner, the pressure (air or fluid) is transferred from the source 420 through the lines 434b, 437 to the second chamber 430 and the pressure is transferred from the first chamber 428 through the lines 436, 435, and 450a to the silencer 422. This causes the backward movement of the piston 426. The speed of the backward movement is controlled via the fuzzy block 416. Specifically, the controller 418 can issue various control signals to the fuzzy block 416 to increase or decrease the backward movement speed of the piston 426.

The first 3/3-way solenoid valve 412 includes input terminals 412a, 412e, a first port 412b, a second port 412c, and a third port 412d. The input terminals 412a, 412e are connected to the controller 418. The first port 412b is connected to the source 420 via line 434a. The second port 412c is connected to the first chamber 428 via the line 436. The third port 412d is connected to the silencer 422 via the fuzzy block 416 and lines 435, 450a. The first 3/3-way solenoid valve 412 includes a first position connecting the first port 412b to the second port 412c, and a second condition connecting the second port 412c to the third port 412d. The first position is activated when the input terminal 412a receives an ON or active signal from the controller 418. The second position is activated when the input terminal 412e receives an ON signal from the controller 418.

The second 3/3-way solenoid valve 414 includes input terminals 414a, 414e, a first port 414b, a second port 414c, and a third port 414d. The input terminals 414a, 414e are connected to the controller 418. The first port 414b is connected to the source 420 via line 434b. The second port 414c is connected to the second chamber 430 via the line 437. The third port 414d is connected to the silencer 422 via the fuzzy block 417 and lines 440, 450b. The second 3/3-way solenoid valve 414 includes a first position connecting the first port 414b to the second port 414c, and a second condition connecting the second port 414c to the third port 414d. The first position is activated when the input terminal 414e receives an ON or active signal from the controller 418. The second position is activated when the input terminal 414a receives an ON signal from the controller 418.

In one implementation, the input terminals 412a and 414a receive the same signal from the controller 418. Similarly, the input terminals 412e and 414e receive the same signal from the controller 418. For example, the input terminals 412a, 414a may receive the ON signal and at the same the input terminals 412e, 414e may receive the OFF signal. Alternatively, the input terminals 412a, 414a may receive the OFF signal and at the same the input terminals 412e, 414e may receive the ON signal.

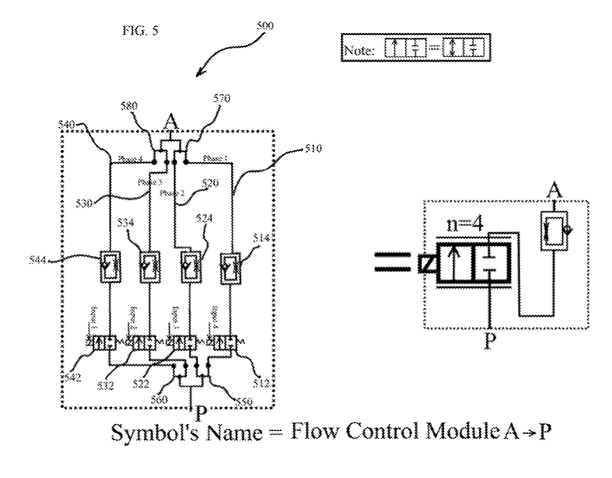

The fuzzy blocks 416, 417 have the same structure and each is configured to control the amount of pressure exist from the cylinder 410. Specifically, the fuzzy block 416 is configured to control the amount of pressure exited from the first chamber 428, and the fuzzy block 417 is configured to control the amount of pressure existed from the second chamber 430. Since fuzzy blocks 416, 417 have the same structure only one of them is described with respect to FIG. 5.

FIG. 5 illustrates exemplary fuzzy block 500. The fuzzy block 500 may correspond to the fuzzy blocks 416, 417 of the actuator 400 shown in FIG. 4. The fuzzy block 500 at one end is connected to point A and at another end is connected to point P. In fuzzy block 416, point A is connected to line 435 and point P is connected to the silencer 422. In fuzzy block 417, point A is connected to line 440 and point P is connected to the silencer 422.

In fuzzy block 500 air or fluid flows from point A to point P and not vice versa. The fuzzy block 500 includes a first phase 510, a second phase 520, a third phase 530, a fourth phase 540, a first three-way fitting 550, a second three-way fitting 560, a third three-way fitting 570, and a fourth three-way fitting 580. The first, second, third and fourth phases are connected in parallel to each other. Specifically, the first phase 510 is connected at one end to point P via the first three-way fitting 550 and at another end to point A via the third three-way fitting 570. Similarly, the second phase 520 is connected at one end to point P via the first three-way fitting 550 and at another end to point A via the third three-way fitting 570. Similarly, the third phase 530 is connected at one end to point P via the second three-way fitting 560 and at another end to point A via the fourth three-way fitting 580. Similarly, the fourth phase 540 is connected at one end to point P via the second three-way fitting 560 and at another end to point A via the fourth three-way fitting 580.

The three-way fittings 550, 560, 570, and 580 are similar to three-way fittings 350, 360, 370, and 380 respectively and therefore they are not described here in more detail for the sake of brevity and simplicity of description.

The first phase 510 includes a first phase solenoid valve 512 and a first phase two-way flow control valve 514. The first phase two-way flow control valve 514 may be manually configured to allow a certain amount of air or pressurized hydraulic to flow through it so that the piston can move with a first speed. The second phase 520 includes a second phase solenoid valve 522 and a second phase two-way flow control valve 524. The second phase flow control valve 524 may be manually configured to allow a certain amount of air or pressurized hydraulic to flow through it so that the piston can move with a second speed. The third phase 530 includes a third phase solenoid valve 532 and a third phase two-way flow control valve 534. The third phase flow control valve 534 may be manually configured to allow a certain amount of air or pressurized hydraulic to flow through it so that the piston can move with a third speed. The fourth phase 540 includes a fourth phase solenoid valve 542 and a fourth phase two-way flow control valve 544. The fourth phase two-way flow control valve 554 may be manually configured to allow a certain amount of air or pressurized hydraulic to flow through it so that the piston can move with a fourth speed.

In one implementation, the first, second, third, and fourth speed are in the descending order. In another implementation, the first, second, third, and fourth speed are in an ascending order.

The controller 418 may be configured to issue control signals for controlling the first and second 3/3-way solenoid valves 412, 414, the 2/2-way solenoid valves 512, 522, 532, and 542, and three-way fittings 550, 560, 570, and 580. The controller 418 may be configured to generate the control signal based on the electrical position signal received from the sensor 424. The controller 418 may compute a difference between the electrical position signal and a reference signal and determine whether the position of the piston 426 is lower than a desired position or higher than the desired position.

Upon determining the piston 426 is lower than the desired position, the controller 418 is configured to issue an ON signal to the input terminals 412a and 414a. This result in connection between ports 412b and 412c thereby connecting source 420 to the first chamber 428. This also results in connection between ports 414c and 414d thereby connecting the second chamber 430 to the silencer 422 through fuzzy block 417. In this configuration, the pressure is entered into the first chamber 428 and is excited from the second chamber 430 through the fuzzy block 417 and the silencer 422. The fuzzy block 417 can control the speed with which the pressure can exit the second chamber 430 and thereby control the speed of forward movement of the piston 426.

The controller 418 also issues a phase control signal to activate one of phases 510, 520, 530, and 540 and thereby connecting the silencer 422 to the second chamber 430 via the one of phases 510, 520, 530, and 540. If the ON control signal from the controller 418 is between 75% to 100% of the maximum value, the first output of the controller 418 activates the input of the first phase solenoid valve 512. The first phase 510 will be ready to actuate the piston 426 by passing pressurized air (pneumatic) or fluid (hydraulic) through the two-way flow control valve 514 from the second chamber 430 to the silencer 422. If the ON control signal from the controller 418 is between 50% to 75% of the maximum value, the second output of the controller 418 actuates the input of the second phase solenoid valve 422. The second phase 520 will be ready to actuate the piston 426 by passing pressurized air (pneumatic) or fluid (hydraulic) through the two-way flow control valve 524 from the second chamber 430 to the silencer 422. If the ON control signal from the controller 418 is between 25% to 50% of the maximum value, the third output of the controller 418 actuates the input of the third phase solenoid valve 532. The third phase 530 will be ready to actuate the piston 426 by passing pressurized air (pneumatic) or fluid (hydraulic) through the two-way flow control valve 514 from the second chamber 430 to the silencer 422. If the ON control signal from the controller 418 is between 0% to 25% of the maximum value, the fourth output of the controller 418 actuates the input of the fourth phase solenoid valve 542. The fourth phase 540 will be ready to actuate the piston 426 by passing pressurized air (pneumatic) or fluid (hydraulic) through the two-way flow control valve 514 from the second chamber 430 to the silencer 422.

Upon determining the piston 426 is higher than the desired position, the controller 418 is configured to issue an ON signal to the input terminals 412e and 414e. This result in connection between ports 412d and 412c thereby connecting silencer 422 to the first chamber 428 through the fuzzy block 416. This also results in connection between ports 414b and 414c thereby connecting the second chamber 430 to the source 420. In this configuration, the pressure is entered into the second chamber 430 and is excited from the first chamber 428 through the fuzzy block 416 and the silencer 422. The fuzzy block 416 can control the speed with which the pressure can exit the first chamber 428 and thereby control the speed of backward movement of the piston 426. To this end, the operation of the fuzzy block 416 will be the same as that of fuzzy block 417 except the pressure is excited from the first chamber 428 instead of second chamber. Therefore, for the sake of brevity of description, the operation of the fuzzy block 416 is not described in more details.

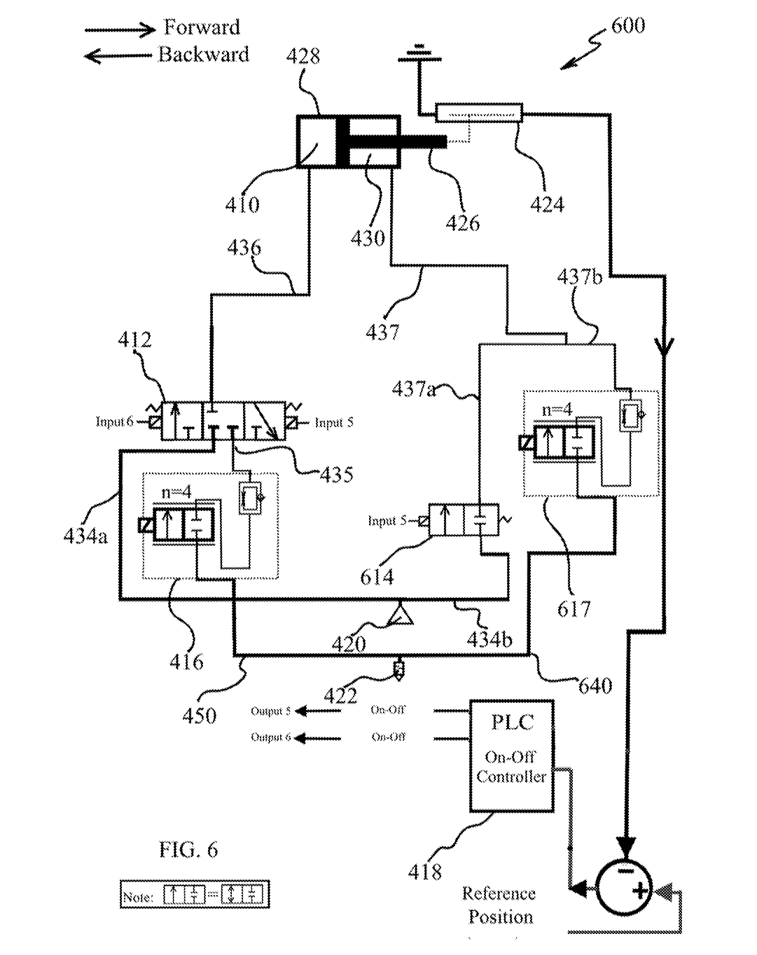

FIG. 6 illustrates another exemplary actuator 600 of the control system 100 shown in FIG. 1. The servo actuator 600 is similar to the servo actuator 400 except the configuration and arrangement of the second 2/2-way solenoid valve 614 and fuzzy block 617 are different from the second 3/3-way solenoid valve 414 and fuzzy block 417. Other elements of the actuator 600 are the same as that of the actuator 400 and therefore they are not described in more detail.

The second 2/2-way solenoid valve 614 at one end is connected to the second chamber 430 of the cylinder 410 via line 437, 437a and at another end is connected to the source 420 via line 434b. The fuzzy block 617 at one end is connected to the second chamber 430 via line 437, 437b and at another end is connected to the silencer 422 via line 640. The structure of the fuzzy block 617 is similar to that of the fuzzy block 500 shown in FIG. 5 and therefore its elements are not described in more detail here for brevity.

If the position signal indicates that the piston 426 is lower than the desired position, the controller 418 activates the first 3/3-way solenoid valve 412 such that the source 420 is connected to the first chamber 428 and activates the fuzzy block 617 such that the second chamber 430 is connected to the silencer 422 through the fuzzy block 617. In this manner configuration, the second 2/2-way solenoid valve 614 is OFF. The pressure (air or fluid) is transferred from the source 420 through the lines 434a, 436 to the first chamber 428 and the pressure is transferred from the second chamber 430 through the lines 437,437b, 640 to the silencer 422 via fuzzy block 617. This causes the forward movement of the piston 426. The speed of the forward movement is controlled via the fuzzy block 617 in a similar manner as described before. Specifically, the controller 418 can issue various control signals to the fuzzy block 617 to increase or decrease the forward movement speed of the piston 426 based on activating one or more of its plurality of phases.

If the position signal indicates that the piston 426 is higher than the desired position, the controller 418 activates the second 2/2-way solenoid valve 614 such that the source 420 is connected to the second chamber 430 and activates the first 3/3-way solenoid valve 412 such that the first chamber 428 is connected to the silencer 422 through the fuzzy block 416. In this manner, the pressure (air or fluid) is transferred from the source 420 through the lines 434b, 437a, 437 to the second chamber 430 and the pressure is transferred from the first chamber 428 through the lines 436, 435, and 450 to the silencer 422 as described with respect to FIG. 4. This causes the backward movement of the piston 426. The speed of the backward movement is controlled via the fuzzy block 416. Specifically, the controller 418 can issue various control signals to the fuzzy block 416 to increase or decrease the backward movement speed of the piston 426.

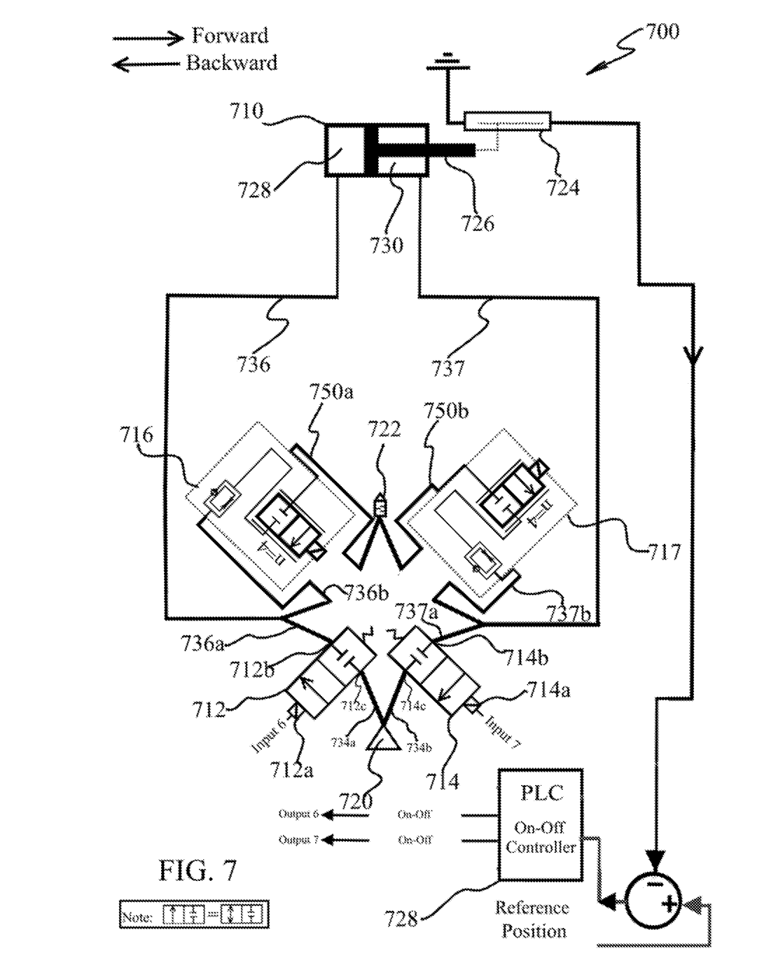

FIG. 7 illustrates another exemplary actuator 700 of the control system 100 shown in FIG. 1. The actuator 700 includes a cylinder 710, a first 2/2-way solenoid valve 712, a second 2/2-way solenoid valve 714, fuzzy blocks 716 and 717, a controller 718, a source 720, a silencer 722, and a sensor 724. The cylinder 710, source 720, silencer 722, and the sensor 724 are similar to cylinder 410, source 420, silencer 422, and the sensor 424, respectively. Therefore, their redundant aspects are not described here in more details for brevity.

The first 2/2-way solenoid valve 712 at one end is connected to the first chamber 728 of the cylinder 710 via line 736, 736a and to the fuzzy block 716 via line 736a, 736b and at another end is connected to the source 720 via line 734a. The fuzzy block 716 at one end is connected to the first 2/2-way solenoid valve 712 via line 736a, 736b and at another end is connected to the silencer 722 via line 750a.

The second 2/2-way solenoid valve 714 at one end is connected to the second chamber 730 of the cylinder 710 via line 737, 737a and the fuzzy block 717 via line 737b, 737a and at another end is connected to the source 720 via line 734b. The fuzzy block 717 at one end is connected to the second 2/2-way solenoid valve 714 via line 737b, 737a and at another end is connected to the silencer 722 via line 750b.

The controller 718 may be similar to controller 418. To this end, the controller 718 may be configured to issue a control signal for controlling the first and second 2/2-way solenoid valves 712, 714, and fuzzy blocks 716, 717. The controller 718 may be configured to generate the control signal based on the electrical position signal received from the sensor 724.

If the position signal indicates that the piston 726 is lower than the desired position, the controller 718 activates the first 2/2-way solenoid valve 712 and the fuzzy block 717 and deactivates the second 2/2-way solenoid valve 714 and the fuzzy block 716. The controller 718 may do this by sending an ON signal to the input terminals of the first 2/2-way solenoid valve 712 and fuzzy block 717 and sending an OFF signal to the input terminals of the second 2/2-way solenoid valve 714 and fuzzy block 716. In this manner, the ports 712b and 712c are connected with each other, thereby connecting the source 720 to the first chamber 728 via lines 736, 736a, and 734a. In this manner, the pressure (air or fluid) is transferred from the source 720 through the lines 736, 736a, and 734a to the first chamber 728 and the pressure is transferred from the second chamber 730 through the lines 737, 737b, and 750b to the silencer 722. This causes the forward movement of the piston 720 within the cylinder 710. The speed of the forward movement is controlled via the fuzzy block 717. Specifically, the controller 718 can issue various control signals to the fuzzy block 717 to increase or decrease the forward movement speed of the piston 726.

The fuzzy block 717 may have the same structure as the fuzzy block 500 shown in FIG. 5. To move the piston with a first speed, the controller 718 may send an ON signal to the first phase solenoid valve in the fuzzy block 717 and send an OFF signal to the remaining solenoid valves in the fuzzy block 717. Similarly, to move the piston with a second speed, the controller 718 may send an ON signal to the second phase solenoid valve in the fuzzy block 717 and send an OFF signal to the remaining solenoid valves in the fuzzy block 717. Similarly, to move the piston with a third speed, the controller 718 may send an ON signal to the third phase solenoid valve in the fuzzy block 717 and send an OFF signal to the remaining solenoid valves in the fuzzy block 717. Similarly, to move the piston with a fourth speed, the controller 718 may send an ON signal to the fourth phase solenoid valve in the fuzzy block 717 and send an OFF signal to the remaining solenoid valves in the fuzzy block 717.

The activated phase connects the second chamber 730 to the silencer 722 through its corresponding two-way flow control valve. The two-way flow control valve may control the amount of pressurized air or fluid that is existing the second chamber 730.

If the position signal indicates that the piston 726 is higher than the desired position, the controller 718 activates the second 2/2-way solenoid valve 714 and the fuzzy block 716 and deactivates the first 2/2-way solenoid valve 712 and the fuzzy block 717. The controller 718 may do this by sending an ON signal to the input terminals of the second 2/2-way solenoid valve 714 and fuzzy block 716 and sending an OFF signal to the input terminals of the first 2/2-way solenoid valve 712 and fuzzy block 717. In this manner, the ports 714b and 714c are connected with each other, thereby connecting the source 720 to the second chamber 730 via lines 737, 737a, and 734b. In this manner, the pressure (air or fluid) is transferred from the source 720 through the lines 737, 737a, and 734b to the second chamber 730 and the pressure is transferred from the first chamber 728 through the lines 736, 736b, and 750b to the silencer 722. This causes the backward movement of the piston 710 within the cylinder 710. The speed of the backward movement is controlled via the fuzzy block 716. Specifically, the controller 718 can issue various control signals to the fuzzy block 716 to increase or decrease the backward movement speed of the piston 726.

The fuzzy block 716 may have the same structure as the fuzzy block 500 shown in FIG. 5. To move the piston with a first speed, the controller 718 may send an ON signal to the first phase solenoid valve in the fuzzy block 716 and send an OFF signal to the remaining solenoid valves in the fuzzy block 716. Similarly, to move the piston with a second speed, the controller 718 may send an ON signal to the second phase solenoid valve in the fuzzy block 716 and send an OFF signal to the remaining solenoid valves in the fuzzy block 716. Similarly, to move the piston with a third speed, the controller 718 may send an ON signal to the third phase solenoid valve in the fuzzy block 716 and send an OFF signal to the remaining solenoid valves in the fuzzy block 716. Similarly, to move the piston with a fourth speed, the controller 718 may send an ON signal to the fourth phase solenoid valve in the fuzzy block 716 and send an OFF signal to the remaining solenoid valves in the fuzzy block 716.

The activated phase connects the first chamber 728 to the silencer 722 through its corresponding two-way flow control valve. The two-way flow control valve may control the amount of pressurized air or fluid that is existing the first chamber 728.

Other implementations are contemplated. For example, although the fuzzy blocks are shown to include 4 phases, they can be configured to include more or less phases. Also, the fuzzy blocks can be configured to control the speed of moving piston within the cylinder in accordance with the Khayyam triangle. To this end, any combination of phases in the fuzzy block may be activated for the forward and backward movement of the piston.

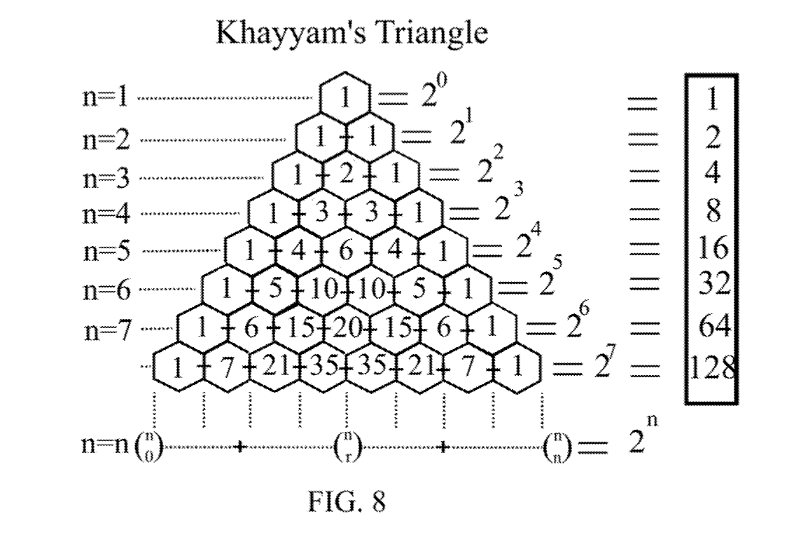

FIG. 8 illustrates an exemplary Khayyam triangle. If n represents the number of phases of the fuzzy block, then the number of speeds for controlling the piston is 2ⁿ−1. In one example, if the n is four as described with respect to FIGS. 3 and 5, the number of speeds possible is equal to 15. The 15 possible speeds include: 1) none of the phases, 2) all of the phases, 3) 1^{st} phase only, 4) 1^{st} and 2^{nd} phases only, 5) 1^{st} and 3^{rd} phases only, 6) 1^{st} and 4^{th} phases only, 7) 1^{st}, 2^{nd}, and 3^{rd} phases only, 8) 1^{st}, 3^{rd}, and 4^{th} phases, 9), 2^{nd} phase only, 10) 2^{nd} and 3^{rd} phases only, 11) 2^{nd} and 4^{th} phases only, 12) 2^{nd}, 3^{rd} and 4^{th} phases only, 13) 3^{rd} phase only, 14) 3^{rd} and 4^{th} phases only, and 15) 4^{th} phase only. To illustrate further, if we assume that the flow total from A to P or P to A from fuzzy block 300 is 15Q, the first phase to fourth phase may be configured such that the flow in the first phase, second phase, third phase, and fourth phase are respectively, 1Q, 2Q, 4Q, and 8Q according to FIG. 8.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. An actuator comprising:
a cylinder configured to receive a piston, the piston defining a first chamber and a second chamber inside the cylinder;
a first 2/2-way solenoid valve including an input terminal and a plurality of ports;
a second 2/2-way solenoid valve including an input terminal and a plurality of ports;
a fuzzy block including a plurality of phases each phase including a 2/2-way solenoid valve and two flow control valves for controlling the speed of movement of the piston within the cylinder;
a controller configured to issue a control signal for controlling the first and second 2/2-way solenoid valves and the 2/2-way solenoid valves included within the plurality of phases;
a source connected to fuzzy block through the first 2/2-way solenoid valve and configured to produce pressure output to the cylinder; and
a silencer connected to the fuzzy block through the second 2/2-way solenoid valve and configured to reduce noise during exist of pressure from the cylinder;
a sensor connected to the piston and configured to sense the position of the piston and send an electrical position signal to the controller, wherein the controller is configured to generate the control signal based on the electrical position signal received from the sensor.

2. The actuator of claim 1, wherein:
the plurality of ports of the first 2/2-way solenoid valve includes a first port and a second port,
the first port is connected to the source,
the second port is connected to the fuzzy block, and
the first 2/2-way solenoid valve includes a first position connecting the first port to the second port, and a second condition disconnecting the first port from the second port.

3. The actuator of claim 2, wherein:
the plurality of ports of the second 2/2-way solenoid valve includes a first port and a second port,
the first port of the second 2/2-way solenoid valve is connected to the silencer,
the second port of the second 2/2-way solenoid valve is connected to the fuzzy block, and
the first solenoid valve includes a first position connecting the first port of the second 2/2-way solenoid valve to the second port of the second port of the 2/2-way solenoid valve and a second position disconnecting the first port of the second 2/2-way solenoid valve from the second port of the second 2/2-way solenoid valve.

4. The actuator of claim 3, wherein the plurality of phases in the fuzzy block includes:
a first phase including a first phase 2/2-way solenoid valve and a plurality of first phase two-way flow control valves;
a second phase including a second phase 2/2-way solenoid valve and a plurality of second phase two-way flow control valves;
a third phase including a third phase 2/2-way solenoid valve and a plurality of third phase flow control valves;
a fourth phase including a fourth phase 2/2-way solenoid valve and a plurality of fourth phase two-way flow control valves,
wherein the first, second, third and fourth phases are connected in parallel.

5. The actuator of claim 4, wherein the fuzzy block further includes:
a first three-way fitting configured to connect the first and the second 2/2-way solenoid valves to the first and second phases; and
a second three-way fitting configured to connect the first and second 2/2-way solenoid valves to the third and fourth phases.

6. The actuator of claim 5, wherein the fuzzy block further includes:
a third three-way fitting configured to connect the first and second phases to the cylinder; and
a fourth three-way fitting configured to connect the third and fourth phases to the cylinder. The actuator of claim 6, wherein:
the first phase 2/2-way flow control valves include a forward valve for manually setting a speed of the piston moving forward to a first speed and a backward valve for manually setting a speed of the piston moving backward to the first speed, wherein during the forward movement of the piston only the forward valve controls the flow of pressurized air or fluid and during the backward movement of the piston only the backward valve controls the flow of the pressurized air or fluid,
the second phase two-way flow control valves include a forward valve for manually setting a speed of the piston moving forward to a second speed and a backward valve for manually setting a speed of the piston moving backward to the second speed, wherein during the forward movement of the piston only the forward valve controls the flow of pressurized air or fluid and during the backward movement of the piston only the backward valve controls the flow of the pressurized air or fluid,
the third phase two-way flow control valves include a forward valve for manually setting a speed of the piston moving forward to a third speed and a backward valve for manually setting a speed of the piston moving backward to the third speed, wherein during the forward movement of the piston only the forward valve controls the flow of pressurized air or fluid and during the backward movement of the piston only the backward valve controls the flow of the pressurized air or fluid,
the fourth phase two-way flow control valves include a forward valve for manually setting a speed of the piston moving forward to a fourth speed and a backward valve for manually setting a speed of the piston moving backward to the fourth speed, wherein during the forward movement of the piston only the forward valve controls the flow of pressurized air or fluid and during the backward movement of the piston only the backward valve controls the flow of the pressurized air or fluid,
the first speed is higher than the second speed,
the second speed is higher than the third speed, and
the third speed is higher than the fourth speed.

8. The actuator of claim 7, wherein the controller is configured to:
compute a difference between the electrical position signal and a reference signal, and
determine whether the position of the piston is lower than a desired position or higher than the desired position.

9. The actuator of claim 8, wherein the controller is configured to:
to issue a first control signal to activate the first 2/2-way solenoid valve upon determining the piston is higher than the desired position, and
to issue a phase control signal to activate one or more of the plurality of phases and thereby connecting the source to the first chamber via the one or more of the plurality of phases.

10. The actuator of claim 9, wherein the controller is configured to:
if the first control signal is between 75% to 100% of a maximum value, issue a first phase control signal to active the first phase 2/2-way solenoid valve by configuring the first three-way fitting to connect the source to the first phase and configuring the third three-way fitting to connect the first phase to the first chamber,
if the first control signal is between 50% to 75% of a maximum value, issue a second phase control signal to active the second phase 2/2-way solenoid valve by configuring the first three-way fitting to connect the source to the second phase and configuring the third three-way fitting to connect the second phase to the first chamber,
if the first control signal is between 25% to 50% of a maximum value, issue a third phase control signal to active the third phase 2/2-way solenoid valve by configuring the second three-way fitting to connect the source to the third phase and configuring the fourth three-way fitting to connect the third phase to the first chamber, and
if the first control signal is between 0% to 25% of a maximum value, issue a fourth phase control signal to active the fourth phase 2/2-way solenoid valve by configuring the second three-way fitting to connect the source to the fourth phase and configuring the fourth three-way fitting to connect the fourth phase to the first chamber.

11. The actuator of claim 10, wherein:
the controller is configured to gradually reduce the forward speed of the piston by alternatively activating and deactivating the one or more of the plurality of phases, and
the controller is configured to control the forward speed of the piston by controlling the operation of the phases in the fuzzy block in accordance with Khayyam Triangle.

12. The actuator of claim 8, wherein the controller is configured to:
to issue a second control signal to activate the second 2/2-way solenoid valve upon determining the piston is lower than the desired position, and
to issue a phase control signal to activate one or more of the plurality of phases and thereby connecting the first chamber to the silencer through the one or more of the plurality of phases.

13. The actuator of claim 12, wherein the controller is configured to:
if the second control signal is between 75% to 100% of a maximum value, issue a first phase control signal to active the first phase 2/2-way solenoid valve by configuring the first three-way fitting to connect the silencer to the first phase and configuration the third three-way fitting to connect the first phase to the first chamber,
if the first control signal is between 50% to 75% of a maximum value, issue a second phase control signal to active the second phase 2/2-way solenoid valve by configuring the first three-way fitting to connect the silencer to the second phase and configuration the third three-way fitting to connect the second phase to the first chamber,
if the first control signal is between 25% to 50% of a maximum value, issue a third phase control signal to active the third phase 2/2-way solenoid valve by configuring the second three-way fitting to connect the silencer to the third phase and configuration the fourth three-way fitting to connect the third phase to the first chamber, and
if the first control signal is between 0% to 25% of a maximum value, issue a fourth phase control signal to active the fourth phase 2/2-way solenoid valve by configuring the second three-way fitting to connect the silencer to the fourth phase and configuration the fourth three-way fitting to connect the fourth phase to the first chamber.

14. The actuator of claim 13, wherein:
the controller is configured to gradually reduce the backward speed of the piston by alternatively activating and deactivating the one or more of the plurality of phases, and
the controller is configured to control the backward speed of the piston by controlling the operation of the phases in the fuzzy block in accordance with Khayyam Triangle.

15. An actuator comprising:
a cylinder configured to receive a piston, the piston defining a first chamber and a second chamber inside the cylinder;
a first solenoid valve including an input terminal and a plurality of ports;
a second solenoid valve including an input terminal and a plurality of ports;
a first fuzzy block including a plurality of phases each phase including a 2/2-way solenoid valve and a two-way flow control valve for controlling the speed of a forward movement of the piston within the cylinder;
a second fuzzy block including a plurality of phases each phase including a 2/2-way solenoid valve and a two-way flow control valve for controlling the speed of a backward movement of the piston within the cylinder;
a controller configured to issue a control signal for controlling the first and second solenoid valves and the first and second fuzzy blocks;
a source connected to the cylinder and configured to produce pressure output to the cylinder; and
a silencer connected to the first and second fuzzy blocks and configured to reduce noise during exist of pressure from the cylinder;
a sensor connected to the piston and configured to sense the position of the piston and send an electrical position signal to the controller, wherein the controller is configured to generate the control signal based on the electrical position signal received from the sensor.

16. The actuator of claim 15, wherein:
the first solenoid valve includes a 3/3-way solenoid valve at one end connected to the first chamber and at another end is connected to a source and the first fuzzy block,
the second solenoid valve includes a 3/3-way solenoid valve at one end connected to the second chamber and at another end is connected to a source and the second fuzzy block, and
the first and second fuzzy blocks are both connected to the silencer.

17. The actuator of claim 15, wherein:
each of the first and second fuzzy blocks include a plurality of phases,
the plurality of phases include:
a first phase including a first phase 2/2-way solenoid valve and a first phase two-way flow control valve;
a second phase including a second phase 2/2-way solenoid valve and a second phase two-way flow control valve;
a third phase including a third phase 2/2-way solenoid valve and a third phase two-way flow control valve;
a fourth phase including a fourth phase 2/2-way solenoid valve and a fourth phase two-way flow control valve,
wherein the first, second, third and fourth phases are connected in parallel.

18. The actuator of claim 15, wherein:
the first solenoid valve includes a 3/3-way solenoid valve at one end connected to the first chamber and at another end is connected to a source and the first fuzzy block,
the second solenoid valve includes a 2/2-way solenoid valve at one end connected to the second chamber and at another end is connected to a source,
the first fuzzy block at one end connected to the first 3/3-way solenoid valve and at another connected to the silencer, and
the second fuzzy block at one end connected to the second chamber and at another end connected to the silencer.

19. The actuator of claim 15, wherein:
the first solenoid valve includes a 2/2-way solenoid valve at one end connected to the first chamber and the first fuzzy block and at another end is connected to a source,
the second solenoid valve includes a 2/2-way solenoid valve at one end connected to the second chamber and the second fuzzy block and at another end is connected to the source,
the first fuzzy block at one end connected to the first 2/2-way solenoid valve and the first 2/2-way solenoid valve and at another connected to the silencer, and
the second fuzzy block at one end connected to the second chamber and the second 2/2-way solenoid valve and at another end connected to the silencer.

20. The actuator of claim 1, further comprising a plant connected to the cylinder, wherein
the plant includes a power plant turbine governor, the governor including a hydraulic or pneumatic governor and having a wicket gate for controlling a speed of a turbine, or
the plant includes a hydraulic or a pneumatic control valve positioner having a control valve with a stem for controlling a position of a control valve.
